(19) United States
(12) Patent Application Publication
(10) Pub. No.: US 2014/0222518 A1
(43) Pub. Date: Aug. 7, 2014

(54) METHODS AND SYSTEMS FOR SETTING OPTIMAL HOTEL PROPERTY PRICES

(71) Applicant: TravelClick, Inc., New York, NY (US)

(72) Inventor: Stephen Adkins, Atlanta, GA (US)

(21) Appl. No.: 14/175,883

(22) Filed: Feb. 7, 2014

Related U.S. Application Data
(60) Provisional application No. 61/762,129, filed on Feb. 7, 2013.

(51) Int. Cl. G06Q 30/02

(52) U.S. Cl. CPC G06Q 30/0206
USPC 705/7.35

(57) ABSTRACT

A method and system for setting the optimal price for a hotel property are described. The method includes the steps of receiving electronic data having marketing information, including, for example, the customers won and lost by competitors. One or more price sensitivity coefficients are calculated based on the market data. The price sensitivity coefficients are used to calculate a predicted share value representing the probability that a next customer will book a property at the subject hotel at a particular price. The price sensitivity coefficients are also used to calculate a price elasticity value representing the responsiveness of demand for the hotel property to a change in the price of that property. The price of the hotel property is set at a point where the price elasticity value is substantially equal to −1.0.

### CROSS-REFERENCE TO RELATED APPLICATIONS

The present application claims the benefit of the earlier filing date of U.S. Provisional Patent Application No. 61/762,129, filed Feb. 7, 2013, now pending.

### FIELD OF THE INVENTION

The disclosure relates to methods for determining optimal prices for hotel properties.

### BACKGROUND OF THE INVENTION

The science of price setting in the hotel industry has been limited by the amount of information available. Previous techniques for determining optimal pricing were generated according to such limited information.

Initially, competitor prices were not as transparent during the consumer buying process, nor were they as quickly and comprehensively available to hotels as they set their own prices. Marketing departments set rates and grouped them into rate categories. Yield management would then depend on an assessment of a hotel's own demand prospects to determine which rates to make available. As demand did or did not materialize, a hotel's available price would rise or fall accordingly. The price would be lowered to try to increase booking pace or raised to get more revenue for each booking as the hotel's room supply dwindled. All of this assumed that the property's own historical demand was a good predictor of future demand regardless of whether the price positions in the past were like the recent and future price positions.

As competitor price data became more readily available, dynamic pricing became more widespread. Hotels and their pricing solution providers also began to align competitive price position to a hotel's booking patterns to estimate the impact of competitive position on demand. This estimation lacked knowledge of market demand—knowing only the “wins” but none of the “losses.” Previous price-setting techniques were created to make up for this shortcoming

### BRIEF SUMMARY OF THE INVENTION

Competitive demand share data now exists and is available to hotels allowing for a much more stable and accurate determination of the effects of competitive prices on demand through the estimation of share. The availability of complete, detailed, and forward-looking market demand data for the hotel industry has been understood to have great potential for advancing the state of the art in hotel pricing analysis, evaluation, strategy, policy, and tactics. However, because such data is relatively new to the industry, techniques have not been available for using the data. The present disclosure describes methods for determining and setting an optimal price for a hotel property by utilizing this information. The disclosed methods provide opportunities not only for the optimization of transient public segment business but also improved management of all segments of a hotel's business.

Embodied Applications: The following are all capabilities that a hotel organization might gain by implementing the methods of the present invention:
Competitor Relevance Evaluation—Determine which competitors' prices affect your share of demand
Competitor Sensitivity—Determine how sensitive you are to each competitors' price
Share Estimation—Estimate how much market share you will get when faced with a particular set of competitor prices
Strategic Price Position Evaluation—Evaluate whether a higher or lower price position would be a better norm for improving revenue
Tactical Competitive Price Evaluation—Evaluate the revenue effects of competitor price changes and potential responses
Tactical Optimal Price Setting—Determine the optimal price to trade off the probability of gaining bookings (and accumulating share and thereby occupancy) versus the raising of average daily rate (ADR) in a booking environment independent of capacity constraints
Revenue Performance Evaluation—Determine how well your revenue managers and your revenue management program have been doing at keeping optimal prices in the market

### DESCRIPTION OF THE DRAWINGS

For a fuller understanding of the nature and objects of the disclosure, reference should be made to the following detailed description taken in conjunction with the accompanying drawings, in which:

FIG. 1 is a graph depicting an revenue curve using exemplary data;

FIG. 2 is a flowchart depicting a method according to an embodiment of the present disclosure; and

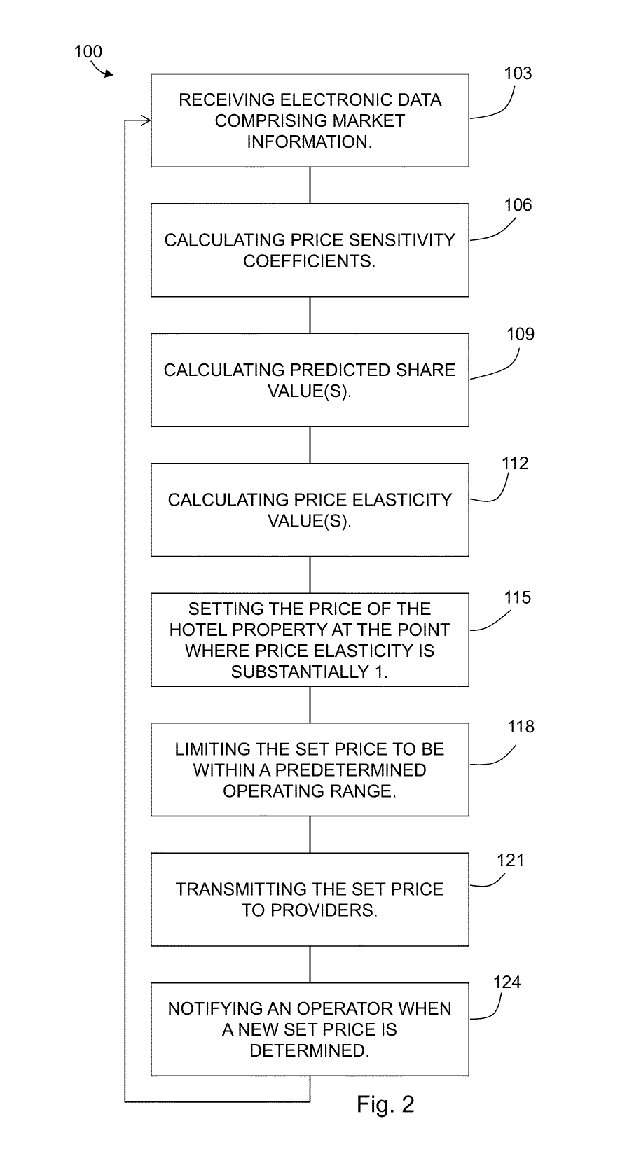

FIG. 3 is a diagram of a system according to another embodiment of the present disclosure.

### DETAILED DESCRIPTION OF THE INVENTION

The present disclosure may be embodied as a method 100 for setting the optimal price for a hotel property. The method 100 is implemented using a computer such that the hotel property price may be set automatically. The method 100 comprises the step of receiving 103 electronic data having marketing information. The electronic data may be any form of non-transient communication as is known in the art. For example, the electronic data may be an electronic file, or it may be an electronic transmission generated from an electronic file (e.g., a query to a database management system, etc.) The market information contained within the electronic data comprises competitive pricing information further described under the heading “Exemplary Embodiment and Discussion” below. The competitive pricing information includes, for example, the customers won and lost by competitors for certain prices of the competitor properties. The term customers is used herein to refer to hotel property customers seeking to book (and possibly booking) hotel rooms.

One or more price sensitivity coefficients are calculated 106 by the implementing computer. The price sensitivity coefficients are calculated 106 based on the market data. The coefficients are calculated 106 using known statistical techniques particularly applied to the objective of determining hotel property pricing. For example, the coefficients are preferably determined 106 using binomial logistic regression modeling (further described below).

The price sensitivity coefficients are used to calculate 109 a predicted share value representing the probability that a next customer will book a property at the subject hotel at a particular price. The price sensitivity coefficients are also used to calculate 112 a price elasticity value representing the responsiveness of demand for the hotel property to a change in the price of that property.

The price of the hotel property is set 115 at a point where the price elasticity value is substantially equal to −1.0. Generally, the sign of the elasticity is ignored, so the price at which the hotel property is set 115 may be said to be where the absolute value of the price elasticity value is substantially equal to 1. The hotel property price may rationalized to prevent a run-away scenario (due to the preferred automatic nature of the method 100). As such, the method 100 may further comprise the step of limiting 118 the set price of the property if the price is outside of a predetermined operating range.

The set price may be transmitted 121, by the implementing computer, to booking providers. In this way, the method 100 may operate in an unattended fashion. The method 100 may be performed repeatedly to maintain optimal pricing for the hotel property in response to a changing competitor environment. The frequency at which the method 100 is repeated may be selected by an operator, and the method 100 may further comprise the step of notifying 124 (e.g., text message, e-mail, etc.) an operator when a new price is set 115. For example, the operator may be notified 124 when the determined set price is different than the previous set price. In another example, the operator may be notified 124 when the determined set price varies from the previous set price by more than a threshold value.

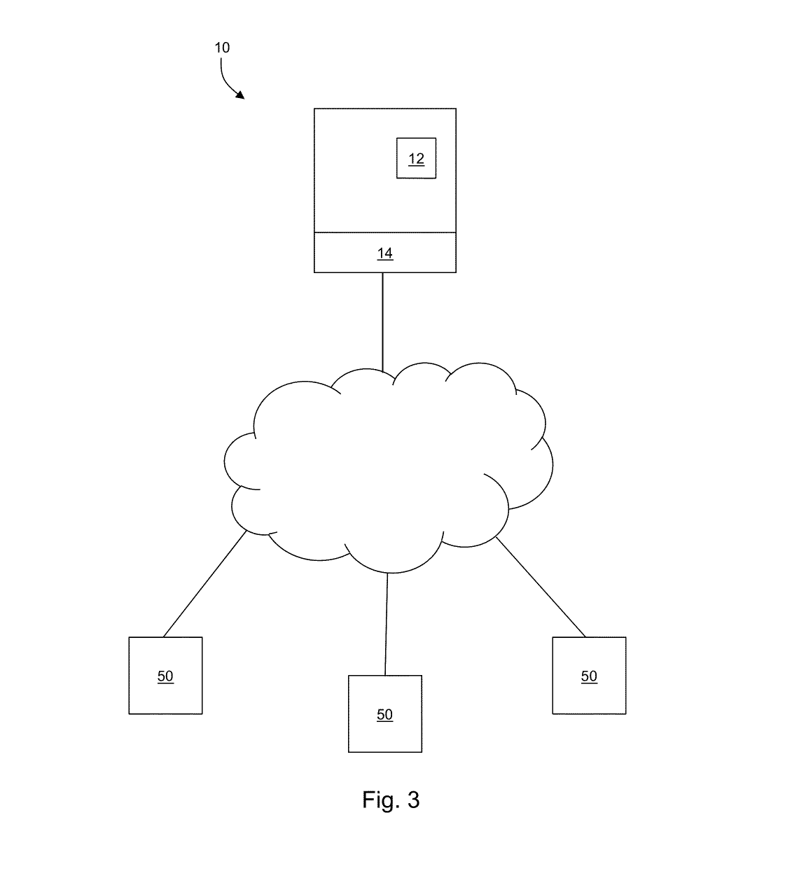

The present disclosure may be embodied as a non-transitory medium having computer-readable instructions for causing a processor to perform embodiments of the method 100 (see, e.g., FIG. 3). The present disclosure may be embodied as a system 10 comprising a processor 12. The system 10 may further comprise a network interface 14 in electronic communication with the processor 12. The processor 12 may be programmed to perform embodiments of method 100. For example, the processor 12 may be programmed to calculate price sensitivity coefficients based on market data received at the network interface 14; to calculate a predicted share value representing the probability that a next customer will book a property at the subject hotel at a particular price; to calculate a price elasticity value representing the responsiveness of demand for the hotel property to a change in the price of that property using the price sensitivity coefficients; and to determine a point at which the price elasticity value is substantially equal to −1.0. It should be noted that throughout this disclosure, embodiments of substantially may include values within up to 1%, 2%_{,} 5%, 10%, or 15% of the desired value. Embodiments of the system 10 may include the processor 12 further programmed to transmit a hotel property price to one or more booking providers 30.

### EXEMPLARY EMBODIMENT AND DISCUSSION

Consider the hypothetical data set for a hotel property shown in Table 1. Each row represents a specific point in time that a specific type of customer booked somewhere within a competitive set of hotel properties and what prices they would have been faced with when making that decision. The assembly of this data set involves four significant stages of complexity each with subtle nuances of its own.

TABLE 1
Hypothetical data set for a hotel property

| | | | | | | | | | | | | | 14 |
|---|---|---|---|---|---|---|---|---|---|---|---|---|---|
| | | | | | 6 | | 8 | 9 | 10 | 11 | 12 | 13 | Rooms |
| 1 | 2 | 3 | | | Rooms | 7 | Comp | Comp | Comp | Comp | Comp | Comp | (Total |
| Arrival | Cust | Days | 4 | 5 | (Own | Own | #1 | #2 | #3 | #4 | #5 | #6 | Comp |
| Dates | Segm't | Left | LOS | Guests | Hotel) | Price | Price | Price | Price | Price | Price | Price | Set) |
| Jun. 1, 2012 | GDS | 240 | 30 | 1 | 0 | 180 | 104 | 94 | 191 | 123 | 107 | 108 | 30 |
| Jun. 1, 2012 | Direct | 131 | 2 | 4 | 0 | 180 | 145 | 138 | 168 | 135 | 85 | 92 | 2 |
| Jun. 1, 2012 | OTA | 123 | 4 | 2 | 0 | 180 | 86 | 84 | 169 | 135 | 92 | 75 | 4 |
| Jun. 1, 2012 | Direct | 54 | 1 | 2 | 0 | 150 | 114 | 138 | 208 | 135 | 100 | 115 | 1 |
| Jun. 1, 2012 | Direct | 30 | 1 | 1 | 0 | 150 | 114 | 138 | 208 | 135 | 100 | 115 | 1 |
| Jun. 1, 2012 | Direct | 5 | 1 | 1 | 1 | 130 | 85 | 148 | 208 | 135 | 118 | 115 | 2 |
| Jun. 1, 2012 | GDS | 4 | 1 | 2 | 0 | 130 | 85 | 148 | 208 | 135 | 118 | 115 | 1 |
| Jun. 1, 2012 | Direct | 4 | 3 | 2 | 0 | 130 | 74 | 99 | 186 | 135 | 83 | 115 | 6 |
| Jun. 1, 2012 | Direct | 4 | 5 | 1 | 0 | 130 | 78 | 87 | 181 | 135 | 95 | 92 | 5 |
| Jun. 1, 2012 | GDS | 3 | 4 | 2 | 0 | 150 | 67 | 84 | 175 | 135 | 92 | 108 | 4 |
| Jun. 1, 2012 | Direct | 2 | 1 | 1 | 2 | 150 | 100 | 148 | 228 | 135 | 118 | 115 | 2 |
| Jun. 1, 2012 | Direct | 2 | 2 | 2 | 0 | 150 | 85 | 133 | 218 | 135 | 97 | 115 | 2 |
| Jun. 1, 2012 | OTA | 1 | 1 | 1 | 2 | 150 | 100 | 148 | 228 | 135 | 118 | 115 | 4 |
| Jun. 1, 2012 | Direct | 1 | 2 | 1 | 0 | 150 | 85 | 133 | 218 | 135 | 97 | 115 | 2 |

Own Demand: The first six columns have been available to hotels for some time. These columns represent a simple aggregation of a hotel property's own bookings. Because this data has been accessible in the past, it was used in early efforts to forecast future demand. The overall level of demand and its seasonality (by the arrival date), the amount of demand remaining yet to book (by the days left), and the length of stay distributions (by the “LOS”) could all be forecasted in this way. However, this method ignored the effects of price on the customer buying behavior. Past demand data can only be expected to be useful to predict future demand if the prices and/or relative prices between competitors are assumed to be similar in the future to what they have been in the past. This is rarely true, and this assumption is a weakness of this approach.

Own Price: The seventh column can be approximated by using the revenue values attached to a property's bookings. However, this may not represent the full price on which a customer based their decision. It generally represents the net revenue to the hotel without the commission taken by the booking channel, market intermediary, agent, or reseller (e.g., online travel agent (“OTA”), global distribution system (“GDS”), etc.)

Own Public Price and Competitor Public Prices: To remedy the problem with “own prices” and also to gain visibility into competitor prices (columns 7 through 13), hotels have previously contracted with price shopping services to gather the public prices as they would have been viewed by the customers. However, prices are often sampled and often don't match exactly the “days left,” LOS, number of guests, or customer segment that exists on actual bookings. These sampled prices may be approximated by referring to other prices, for example, the larger set of publicly collected rates that have been stored historically. The sampled prices may be an estimation of the actual rate that a customer evaluated when deciding to book a room. The collection of such sampled pricing data was an improvement for the hotel industry, but it is deficient due to the aforementioned errors and/or assumptions, and in particular, because the data does not include the number of bookings lost to competitors. Hotels have done their best to work around these deficiencies and estimate the effects of competitive prices on demand based on these limited data elements.

Competitor Demand: Using embodiments of the present disclosure, more accurate and definitive calculations can be made by the use of data including the number of customer rooms lost to competitors under the same pricing conditions. If a hotel had information including the number of customers both won and lost at a given set of competitive prices, the accuracy with which optimal pricing could be predicted is improved. Such data, the number of rooms booked in the entire competitive set (column 14), has recently become obtainable.

Model Assumptions of Customer Buying Behavior

Transient Public Customer Segments: Customers who buy hotel rooms based on public rates belong to and are part of the Transient market segment. They may be buying retail rates (best available, non-qualified, unrestricted), discount rates (generally with restrictions), or qualified rates (such as government rates, AAA rates, or AARP rates).

Customers of the Competitive Set: When such a customer wants to purchase a hotel room, he usually has an idea of where he wants to stay (location) and what type of hotel he wants to stay in (hotel segment, or chain scale). As a result, it is expected that he will book a room at the hotel of interest or one of its competitors.

Reference Market Share: The customer may already know what specific properties or brands he prefers, perhaps because of a guest loyalty program, a referral, or prior experience. He has a variety of feature and accommodation preferences and certain expectations about prices and value-for-money trade-offs at various hotel properties. As long as room availability and prices are approximately as he expects, he has a set propensity to purchase one hotel or another. From the hotel's perspective, there is a baseline or reference probability between 0% and 100% that each such customer of the competitive set will book with their hotel as opposed to with a competitor. In aggregate, the group of such customers, when faced with unsurprising and familiar prices, will make choices which result in a baseline or reference market share for that property.

Stable and Dynamic Effects on Market Share: Thus, the reference share is the result of many factors including the typical or reference prices. Many of those factors are difficult to change or slow to change. As a result, the Reference Share is considered to be relatively stable. The difference between the reference share and the actual share is a result of prices which are different than the reference prices. Prices are the easiest way to affect actual share because they are dynamic and are almost always a part of the customer's buying decision.

Effects of Booking Channels: When a customer wishes to buy a hotel room, that customer will generally book through one of three channels. They may use an OTA such as Travelocity or Expedia, where they will see many properties along with the current prices for those properties. It is expected that someone shopping through an OTA will be the most price sensitive. Alternatively, they may book through a travel agent who is using a GDS. These customers would still be price sensitive but perhaps less so than those that book through an OTA. Finally, they may book directly with the hotel by going to the hotel's public website (i.e., “Brand.com”), by calling a toll-free number for the hotel's CRS, or by calling or walking in to the property directly. The price sensitivity of the customer through the direct channel is expected to be the least of all.

Price Position Variance Percent as a Mover of Share: When a customer is confronted with actual prices, he gets a sense of a good value hotel and then compares that hotel to other hotels based on the difference in price relative to the perceived benefits of each. The difference in price between two hotels is called the price position. The customer expects a certain price position (the reference price position) based on what prices have customarily been offered. When the actual price position varies from the reference price position, the customer begins to weigh whether he should change his mind about which hotel he prefers. Furthermore, a $20 difference in a market that sells rooms for $100 per room night is expected to have a greater effect than the same difference in a market that sells rooms for $400 per room night. Thus the customer is swayed in inverse proportion to a scaling factor such as the Market Reference Price. The ratio of the Price Position Variance to the Market Reference Price is the Price Position Variance Percent (“PPVP”). The degree to which the customer's decision is altered by a given PPVP is his price sensitivity.

Model Assumptions from the Hotel's Perspective

The assumptions about customer buying behavior can be restated from the hotel's perspective.

Lead Hotel and Competitor Hotels: Every hotel property has a set of competitor properties that compete for some of the same customers. This hotel is called the “lead hotel” (generally) or the “own hotel” (from the owner's or operator's perspective). Together the lead hotel and its competitors make up a “competitive set.” Pricing, product, and marketing actions taken in any of the competitor hotels are expected to affect the business in the other hotels including the lead hotel.

Reference Share at Reference Prices: The lead hotel generally has an expectation of the market share that he usually gets based on typical prices. This share is called the “reference share” and the typical prices are called “reference prices.” Many market realities contribute to this reference share: branding, hotel features, location, customer loyalty, and customer preferences. Many of these realities are stable in the short term. If the prices remain at their reference levels, it would be predicted that the shares would stay at their reference levels.

Actual Share as a Function of Actual Competitor Prices: Prices do change. Customers considering which hotel to stay in weigh many factors, and one of them is price. When the difference between the lead hotel's prices and the competitors' prices are different than usual, there is a marginal tendency for customers to select the hotel that is less expensive than usual. In this case, the actual market share of the lead property would be expected to be different than the reference share.

Linearity Within Operating Ranges: Analytical models often produce unexpected and unbelievable results when they are extrapolated beyond a reasonable range. The model must be centered around a believable operating baseline condition (reference share achieved at reference price positions). Then it is quite reasonable to suppose that there are proportional effects caused by deviating from this operating baseline. For a limited operating range, this effect can be considered linear.

A First Pass Linear Model

As a first pass, the predicted market share (S) might be represented by a formula like this.

$$S = {S}_{R} + {\sum }_{i} {E}_{i} \cdot P P V {P}_{i} = {S}_{R} + {\sum }_{i} {E}_{i} \cdot \frac{( P - {P}_{i} ) - ( {P}_{R} - {P}_{Ri} )}{{P}_{RM}} \qquad ( 1 )$$

Predicted Share: (S) The predicted share is the probability of winning the next customer booking in the comp set for our own property. In aggregate, this will be the same as the resulting share for periods of time when the own hotel is open and has positive availability.

Reference Share: (S_{R}) The reference share is the estimate of the predicted share which will occur when every hotel is priced exactly equal to their reference (or expected, or average) prices. Each PPVPᵢ is equal to zero.

Own Price: (P) The Lead Property's own price is known as P. This is the lowest unqualified rate that was being offered by the property.

Competitor Price: (Pᵢ) The prices of each of the “1” competitors are collectively (or individually within a sum) known as Pᵢ. These are the lowest unqualified rates that were being offered by the properties.

Own Reference Price: (P_{R}) The reference price of the Lead Property is the weighted average (by competitive set demand) of the publicly available rates for that property. Prices that were in force when a lot of booking activity was occurring across the competitive set are therefore weighted more heavily than prices that were in force when no booking activity was occurring. Reference prices are computed independently for the three public customer segments (Direct, GDS, and OTA) and for each Day of Week Type (Daily and Weekend).

Competitor Reference Price: (P_{Ri}) The reference price for each competitor is computed the same way that the Own Reference Price is computed in a demand-weighted average.

Market Reference Price: (P_{RM}) The Market Reference Price is a capacity-weighted average of all of the Competitor and Own Reference Prices in the competitive set.

Reference Price Position: (PP_{Ri}=P_{R}−P_{Ri}) The Reference Price Position represents the normal price difference between the lead property and one of its competitors that customers and competitors have come to expect.

Price Position: (PPᵢ=P−Pᵢ) The Price Position is the actual price difference between the lead property and one of its competitors. When this is greater than the Reference Price Position, it is expected that the lead property will receive a proportionally lower share. When this is less than the Reference Price Position, greater share would be expected.

Price Position Variance: (PPVᵢ=PPᵢ−PP_{Ri}=((P−Pᵢ)−(P_{R}−P_{Ri}))) The difference between the Price Position and the Reference Price Position is known as the Price Position Variance.

Price Position Variance Percent: (PPVPᵢ=PPVᵢ/P_{RM}) The effect of a given Price Position Variance on the share would be greater at a smaller price level and lower at a higher price level. Therefore, the Price Position Variance Percent is a normalized version of the Price Position Variance by dividing by the Market Reference Price. This value may be clipped at +1.0 and −1.0 to ensure that outliers do not have an inappropriately large negative effect on the model.

Price Sensitivity Coefficients: The Eᵢ constants are the price sensitivities. When all of the price positions do not vary from the reference values, the PPVPᵢ values are all zero and the predicted share (S) is simply equal to the reference share (S_{R}).

This linear relationship suggests that a multivariate regression run on historical demand data samples would yield the price sensitivity coefficients. However, attempts to build such models are problematic for two reasons. First, the historical data will almost always contain samples where S is 0% (0 out of 1) or 100% (1 out of 1) because very few bookings happen at exactly the same time for a future date with similar customer characteristics. Second, this formulation allows that some values of PPVPᵢ would result in values for the share (S) that are greater than 1.0 (100%) or less than 0.0 (0%).

Binomial Logistic Regression Model

The preferred embodiment of the present disclosure solves these problems by using binomial logistic regression—a type of regression analysis used for predicting the outcome of a categorical variable with only two outcomes (success/failure) based on one or more predictor variables. In this case, the two possible outcomes are “the customer booked at our hotel” (success) or “the customer booked at some other hotel in the competitive set” (failure), and the predictor variables are the prices (or more specifically, PPVP). The result of the regression is the ability to estimate the probability of each incremental customer of the competitive set booking our hotel as a function of the available prices. In aggregate, this is an estimation of the share.

Using binomial logistic regression, the model formulation becomes:

$$z - {z}_{R} + {\sum }_{i} {E}_{i} \cdot P P V {P}_{i} = {z}_{R} + {\sum }_{i} {E}_{i} \cdot \frac{( P - {P}_{i} ) - ( {P}_{R} - {P}_{Ri} )}{{P}_{RM}} \qquad ( 2 )$$

Log Odds and the Logit Transformation:

$$( z = ln ( \frac{S}{1 - S} ) )$$

In accordance with the Binomial Logistic Regression, the regression produces an estimate of the log of the odds of a successful outcome rather than the probability or share itself. After the regression is run and the Log Odds (or “Logit”) is computed, the share can be computed in turn.

Price Sensitivity Coefficients: (Eᵢ) The “share” function says that the log odds (z) based on prices is equal to the reference log odds (z_{R}) plus the sum of the share effects from each of the Price Position Variance Percents, each scaled by a price sensitivity coefficient, E. The purpose of the regression is to calculate the coefficients, Eᵢ, and the reference log odds, z_{R}, based on historical demand samples. It also computes the explanatory power of the overall model and the statistical significance of each coefficient.

Predicted Share:

$$( S = \frac{{e}^{z}}{1 + {e}^{z}} )$$

Once the coefficients are computed from historical data samples, they can be used to examine any set of future competitive prices to calculate “z”, the log odds. From that, the expected share, S, can be computed.

Incremental Expected Revenue: (IR=S·P) The “incremental expected revenue per comp set room” is simply the expected share (or probability of getting the booking from the next customer of the competitive set) multiplied by the price (daily room rate) at which that booking would be taken. The task of maximizing revenue in a scenario unconstrained by capacity limits amounts to the same task as maximizing incremental expected revenue.

### Considerations in Embodiments

Public Customer Segments: Only the “Transient” business for channels which support dynamic pricing are subject to the above-described embodiment. This includes Transient Retail, Discount, and Qualified market segments. Furthermore, only the channels for which public price histories have been collected can be analyzed. The segments of demand that meet these criteria are:
OTA—Demand which is booked through Online Travel Agents (OTA's);
GDS—Demand which is booked through the Global Distribution System, not including Wholesale, Negotiated, or Group demand; and
Direct—Demand which is booked through the company website (“Brand.com”), its CRS, or directly to the property.

Non-Public Customer Segments: A hotel's performance is not solely governed by publicly available rates. Other embodiments of the present disclosure may account for customer segments which respond to private or negotiated rates. The public segment analysis can inform the annual negotiation process that affect these segments, the allocation of room blocks to these segments, or the spot price of displaced demand. These segments are:
Group—Demand sold through the Group Sales department for conferences, meetings, and events;
Wholesale—Demand sold through wholesalers, often for tours;
Negotiated—Demand sold at a pre-negotiated rate for governments or corporations;
Opaque—Demand sold through the OTA's where the customer buys the room at deeply discounted prices but without being able to choose the exact property; and
Contract/Crew/Other—Demand sold as a block of rooms negotiated to be available to flight crews of an airline.

Day-of-Week Types: Hotels sometimes compete with different hotels and at different reference prices for Weekday rates (Sunday night through Thursday night) than they do for Weekend rates (Friday night through Saturday night).

One Model or Many: The three public customer segments, each evaluated on Weekdays/Weekend, make up six portions of demand that would each be expected to have different reference share, reference prices, and price sensitivity coefficients. In order to get separate price sensitivity coefficients, embodiments of the present disclosure may separate historical demand samples into six different regressions. However, each regression has fewer samples to work with in order to establish statistical significance. If the samples are kept together in one regression, there can only be one set of coefficients, but the number of samples is much higher. Experience with the data thus far suggests that performing a single regression with a year's worth of historical demand samples produces the most reliable results. We note, however, that both techniques are considered within the scope of the present disclosure.

Competitor Selection and Relevance: One of the side effects of determining price sensitivity coefficient for share estimation is the validation (or invalidation) of the assumptions about relevant competitors. Generally, competitive sets have been created for a variety of reasons, and it is possible that some of the members of the competitive set are not highly significant share estimation. Their price sensitivity coefficients are either small or not significantly different from zero in a statistical sense. It has been discovered that the disclosed analytical technique is useful both for removing insignificant properties from a competitive set and for adding significant properties to it.

Comments on Data Preparation

Historical Demand Samples: Demand history is made up of many demand samples. The demand samples contain a large variety of win-loss scenarios where the lead property competed with the other competitor properties for each booking according to the publicly presented prices. Each demand sample consists of:
the actual number of bookings for the Lead Hotel (rooms arriving),
the actual number of bookings for the rest of the competitors, and
the public rates for the Lead Hotel and each of its competitors
at a particular point in time (number of days left prior to arrival),
for an arrival date,
for a specific length-of-stay (LOS),
for a specific number of guests
from a particular customer segment (combination of booking source and market segment)

Historical Public Rate Estimation: A large database of historical publicly available rates has been collected. However, rates may not have been collected for the particular combination(s) of circumstances under which each historical booking occurred. Therefore, filling and estimation processes may be used to supplement the public rates attributable to each property in the historical sample. For example:
If a rate was not collected at exactly the correct day prior to arrival, the most recently collected rate before that day is used, assuming that the rate would not have changed.
If a rate was not collected as early as the booking occurred, it is assumed that the first time the rate was collected, that it had been in force for all time until then.
If a rate was not collected for the specifically booked number of guests, then the rate for one guest would be used.
If a rate was not collected for the specifically booked length of stay, then the rates from smaller length of stay segments that span the entire period would be averaged.
If a rate was not collected for the specific booking source, then a similar booking source's rate would be used.

Closures: Data samples where the lead property is closed or where the price for the lead property is not known are excluded. Whenever a price is too high above the average, it is assumed that only special room types such as specialty suites remain available, and the hotel is considered closed. Whenever a competitor is closed, it is assumed that the rate was high for the purpose of the model because demand would be expected to flow to the lead property in that case.

Optimal Prices

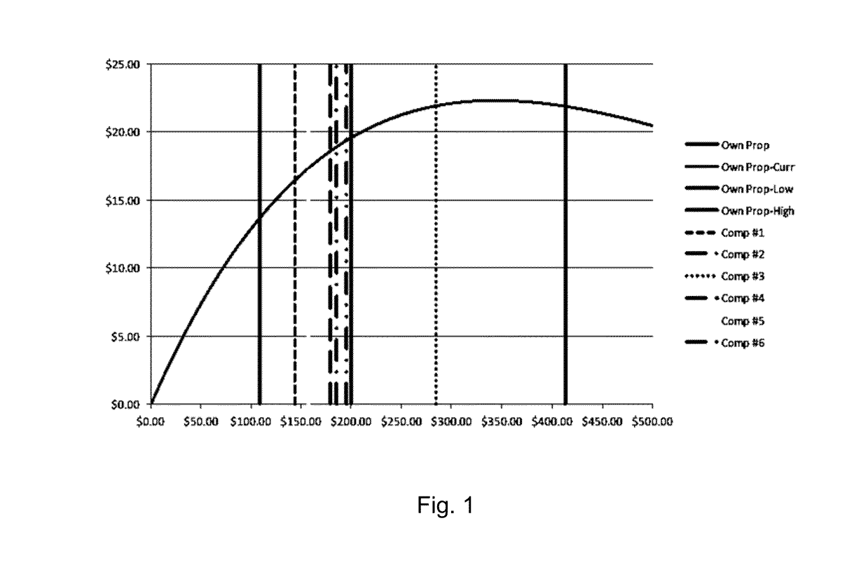

The price optimization problem can be visualized in the graph of exemplary data shown in FIG. 1. The own property's current price and its competitors' current prices are shown as vertical lines staked at fixed price points on the x-axis. These are superimposed over a graph of the Incremental Expected Revenue per Comp Set Room curve which is a function of the price for the own property. The graph shows that the current price of $200 will produce about 15% less expected revenue than the optimal $345 price.

Optimality in the Trade-off Between Price and Share: The idea that there exists an optimal price which maximizes revenue even without capacity constraints is based in the opposing effects of price and share. When prices are zero, high share would be expected, but no revenue would be earned. As those prices rise, the revenue would rise. As the prices rise even more, customers begin considering the trade-off of value for money more carefully, and share declines. If prices are extraordinarily high, share would approach zero, resulting again in zero revenue. Intuitively therefore, there exists a price in the middle where the total revenue (share times price) is at a maximum.

Finding the Optimal Price: To find this maximum, we need to express our expected revenue as a function of our own price. The maximum revenue is found where the slope of that curve is zero. Alternatively and equivalently, in accordance with economic theory, the maximum revenue is found where the Price Elasticity is equal to −1.

Log Odds as a Linear Function of Price: (z=A+B·P) Whenever all of the competitor's prices, the reference prices, the market reference price, the price sensitivity coefficients, and the reference share are known, the formula for log odds reduces to a simple linear relation in P, the price of the lead hotel. Thus the constants A and B can be known in any specific competitive situation, setting the stage for computing the share based on a hotel's own price and computing thereby an optimal price.

Price Elasticity:

$$( η = \frac{d Q}{d P} \cdot \frac{P}{Q} = \frac{B \cdot P}{( 1 + {e}^{( A + B \cdot P )} )} )$$

The price elasticity varies along the revenue curve. The revenue is maximized at the place where the price elasticity is −1.0. If the elasticity is lower than 1 (in absolute value terms), the region is said to be “inelastic,” and the total revenue is increased by raising the price. If the elasticity is greater than 1.0, the region is said to be “elastic” and the total revenue is increased by lowering the price.

Revenue Function:

$$( R = P \cdot S = P \cdot \frac{{e}^{( A + B \cdot P )}}{( 1 + {e}^{( A + B \cdot P )} )} )$$

The optimal price that maximizes revenue is where this revenue function peaks and its derivative (slope) equals 0. The optimal price is also where the price elasticity equals −1.0. This cannot be solved for in closed form and must be solved numerically.

Limiting Optimal Prices to the Operating Region: The computation of an “optimal” price may not be trusted if it falls outside of the operating region between the lowest rates and the highest rates with which the hotel operator has experience and is comfortable. This would be an unwarranted extrapolation along the fitted revenue function. Therefore, the optimal price may be limited by upper and lower bounds set by policy and experience.

Revenue Opportunity

Historical Share Estimation Validation: Historical share is based in fact. The lead property received a real number of room nights and the entire competitive set received a larger number of room nights. The share estimation model does not predict whole numbers of rooms but probabilities or “fractional rooms.” The historical demand samples can be replayed as a sort of simulation using the share estimation model to verify that the resulting estimated share aggregated across all historical demand samples adds up to be equal to the actual historical share. This also gives a baseline revenue number which is based on the publicly available rates.

Historical Revenue Opportunity: The historical revenue opportunity is an assessment of how much additional revenue could have been gained if the optimal own prices had been in place at each moment in history. The optimal own price is computed for each historical demand sample, the resulting estimated share is computed, and the resulting revenue is aggregated. The difference between this revenue and the revenue computed during historical share estimation validation represents the revenue opportunity of optimizing prices.

Recent Revenue Opportunity: The same technique can be used to determine revenue opportunity using the last seven days of demand samples. This gives an indication of how much revenue could have been gained in that week by setting and maintaining optimal prices in the marketplace.

Future Revenue Opportunity: Combined with a forecast of competitive set demand, the same technique can be used to estimate the amount of revenue that could be gained over the next week by setting and maintaining optimal prices.

Although the present disclosure has been described with respect to one or more particular embodiments, it will be understood that other embodiments of the present disclosure may be made without departing from the spirit and scope of the present disclosure. Hence, the present disclosure is deemed limited only by the appended claims and the reasonable interpretation thereof

What is claimed is:

1. A computer-based method for setting the optimal price for a hotel property, the method comprising the steps of:
receiving electronic data having market data including the number of customers won and lost by competitors at corresponding prices;
calculating one or more price sensitivity coefficients based on the market data;
calculating a predicted share based on the price sensitivity coefficients;
calculating a price elasticity value based on the price sensitivity coefficients;
setting the price of the hotel property at a point where the price elasticity value is substantially equal to −1.0.

2. The method of claim 1, further comprising the step of limiting the set price if the set price is outside a predetermined operating range.

3. The method of claim 1, further comprising the step of transmitting the set price of the hotel property to booking providers.

4. The method of claim 1, wherein the one or more price sensitivity coefficients are calculated using a binomial logistic regression.

5. A computer-based method for setting the optimal price for a hotel property, the method comprising the steps of:
receiving competitor market data including a plurality of hotel property prices and the number of customers won and lost by competitors at each price of the plurality of prices;
calculating price sensitivity of hotel property based on the market data;
determining an optimal price as the point of maximum revenue based on the price sensitivity; and
automatically setting the price of the hotel property at the optimal price.
